(19) United States
(12) Patent Application Publication
(10) Pub. No.: US 2016/0164139 A1
(43) Pub. Date: Jun. 9, 2016

(54) Monolithic Ionogel With Biopolymer Matrix, and Method for Manufacturing Same

(71) Applicants: HUTCHINSON, Paris (FR); CENTRE NATIONAL DE LA RECHERCHE SCIENTIFIQUE, Paris (FR); UNIVERSITE DE NANTES, Nantes (FR)

(72) Inventors: David Ayme-Perrot, Huningue (FR); Carole Cerclier, La Chapelle Sur Erdre (FR); Jean Le Bideau, Nantes (FR); Nela Buchtova, Angers (FR); Aurélie Guyomard-Lack, Beaucouze (FR); Philippe-Franck Girard, Chateaufort En Yvelines (FR)

(73) Assignees: Hutchinson, Paris (FR); Centre National de la Recherche Scientifique, Paris (FR); Universite de Nantes, Nantes (FR)

(21) Appl. No.: 14/907,521

(22) PCT Filed: Jul. 29, 2013
(86) PCT No.: PCT/FR2013/051825

§ 371 Date: Jan. 25, 2016

(51) Int. Cl. H01M 10/0565

(52) U.S. Cl. CPC H01M 10/0565

(57) ABSTRACT

The invention relates to a monolithic ionogel with an organic confinement matrix for at least one ionic liquid, and a method for manufacturing same. An ionogel according to the invention comprises a biopolymer confinement matrix with a cross-linked polysaccharide base and an ionic liquid confined in a network formed by the matrix, and it is such that the polysaccharide has siloxane cross-linking bridges, the ionogel being a chemical gel able to constitute a self-supported solid electrolyte by itself. This ionogel is obtained using a method comprising silanisation of the polysaccharide in a basic aqueous solution by a silanisation agent, and polycondensation of the silanised polysaccharide. In a first embodiment, this method comprises preparing a hydrogel with a polysaccharide base that is silanised and cross-linked by sol-gel, then exchange reactions of solvents with increasing hydrophobicities. In a second preferred embodiment, it comprises mixing a first solution comprising the ionic liquid in an acid medium and a second solution containing the silanised and non-cross-linked polysaccharide, such that its cross-linking takes place through that mixing.

The present invention relates to a monolithic ionogel comprising an organic matrix of biopolymer type (i.e. a “biobased” ionogel) which confines at least one ionic liquid, and to a process for producing this ionogel including two modes of implementation which result in two distinct ionogels. The invention generally applies to devices using flexible, monolithic, ionic conducting gels (in particular for energy-storing devices such as batteries, cells, photovoltaic cells), membranes for separating gases or liquids, electrodialysis membranes, sensors and a stationary phase in chromatographic analysis, by way of example that is in no way limiting.

It has for a long time been known practice to manufacture gels by means of a sol-gel process of hydrolysis and condensation which, starting from a molecular precursor (called “true” solution), results in the formation of a colloidal solution (called “sol”) then, by connection of the colloidal particles, in the formation of a continuous solid skeleton called a gel.

Furthermore, ionic liquids are formed by the association of cations and anions and are in the liquid state at a temperature close to ambient temperature. They have notable properties, such as zero volatility, a high ionic conductibility and also catalytic properties.

It is in particular known practice to confine an ionic liquid in a confinement matrix forming a continuous solid skeleton so as to obtain an ionogel, i.e. a gel confining an ionic liquid which preserves its ionic conductivity. The ionic liquid thus confined remains by definition contained in the matrix, without running therefrom or evaporating therefrom.

Such ionogels are in particular presented in patent document WO-A1-2005/007746, which teaches forming a monolithic ionogel comprising a rigid confinement matrix of mineral or organomineral type (i.e. essentially inorganic) by polycondensation of a sol-gel molecular precursor comprising hydrolyzable group(s), such as an alkoxysilane, which is premixed with the ionic liquid and which forms this confinement matrix after polycondensation.

Patent document WO-A1-2010/092258 teaches manufacturing a composite electrode for a lithium battery by casting an ionogel on a porous composite electrode, simultaneously forming the electrolyte-impregnated composite electrode and the separator electrolyte comprising a rigid matrix which is also mineral or organomineral. This ionogel is obtained by mixing an ionic liquid, a lithium salt and this same sol-gel precursor, such as an alkoxysilane.

Moreover, it has in the past been sought to synthesize ionogels comprising a biopolymer confinement matrix (i.e. based on an organic polymer derived from biomass, that is to say produced by a living being) such as a polysaccharide, as, for example, presented in the article Interaction of Ionic Liquids with Polysaccharides, 8 Synthesis of Cellulose Sulfates Suitable for Polyelectrolyte Complex Formation; Gericke, M., Liebert, T., Heinze, T. Macromol. Biosci. 2009, 9, 343-353. A major drawback of the ionogels obtained in this article lies in the fact that they are exclusively rigid physical gels (i.e. gels with physical crosslinking, i.e. with weak bonds which are reversible and deformable under stress according to the physical conditions, such as the temperature). Another drawback of these known ionogels comprising a biopolymer matrix is that the ionic liquid confined must be hydrophilic.

An objective of the present invention is to provide an ionogel comprising a biopolymer confinement matrix for at least one ionic liquid which in particular overcomes these drawbacks, and this objective is achieved in that the applicant has just discovered that the controlled chemical crosslinking of a polysaccharide with a silanizing agent forming Si—O—Si siloxane crosslinking bridges between the polymer chains of the polysaccharide makes it possible, surprisingly, to obtain a flexible monolithic ionogel which is stable even at temperatures of about 200° C. and which has high performance levels.

A monolithic ionogel according to the invention thus comprises a biopolymer confinement matrix based on at least one crosslinked polysaccharide and at least one ionic liquid confined in a network formed by said matrix, and this ionogel is characterized in that said at least one polysaccharide has siloxane crosslinking bridges, the ionogel being a chemical gel capable of constituting a self-supported solid electrolyte by itself (this self-supported characteristic being due to the monolithic nature of the ionogel).

It will be noted that this chemical gel according to the invention (i.e. with chemical crosslinking and with strong bonds giving it stability and performance levels which are long lasting even at temperatures of about 200° C.) can advantageously be formed from a self-supported film which has an average thickness greater than or equal to 10 μm (preferably between 15 μm and 200 μm), and an ionic conductivity at 25° C. greater than or equal to 0.7 mS·cm⁻¹.

It will also be noted that an ionogel according to the invention forms a host network crosslinked by the siloxane bridges, and that the ionogel exhibits high flexibility which has been verified by means of manual bending tests.

It will also be noted that said at least one ionic liquid which is usable in this ionogel of the invention may be, without implied distinction, of hydrophilic or hydrophobic type, contrary to the abovementioned article.

According to another characteristic of the invention, said confinement matrix may be devoid of any molecular precursor of sol-gel type derived from silane, such as an alkoxysilane, contrary to the ionogels of the abovementioned patent documents.

By way of polysaccharide, all the known linear or branched polysaccharides, corresponding in particular to the formula —[Cₓ(H₂O)_{y})]ₙ— where y is generally equal to x−1, are usable in the present invention.

Preferably, said at least one polysaccharide is a cellulose-based derivative chosen from the group consisting of hydroxyethylcellulose, hydroxyethylmethylcellulose, hydroxypropylcellulose, hydroxypropylmethyl-cellulose, hydroxypropyloxymethoxycellulose and mixtures thereof. As a variant, polysaccharides other than cellulose-based derivatives are usable.

Likewise, preferentially, said at least one polysaccharide has groups capable of forming said siloxane crosslinking bridges, as, for example, presented in patent document WO-A1-97/05911 and in the article Synthesis and General Properties of Silated-Hydroxypropyl Methylcellulose in Prospect of Biomedical Use; Bourges, X. Weiss, P. Daculsi, G. Legeay, G. Adv. Colloid Interface Sci. 2002, 99, 215-228.

Preferably, said at least one ionic liquid comprises:
by way of cation, a nucleus which comprises a nitrogen atom and which is chosen from imidazolium, pyridinium, pyrrolidinium and piperidinium nuclei, this nucleus preferably being substituted on the nitrogen atom with one or two alkyl groups having from 1 to 8 carbon atoms and on the carbon atoms with one or more alkyl groups having from 1 to 30 carbon atoms, and
by way of anion, a halide, a perfluoro anion, a phosphonate, a dicyanamide or a borate, said anion preferably being a bis(trifluoromethanesulfonyl)imide.

Even more preferentially, said at least one ionic liquid is chosen to be hydrophobic and comprises, for example, a cation comprising a pyrrolidinium nucleus and a bis(trifluoromethanesulfonyl)imide anion.

According to another general characteristic of the invention, said ionogel may comprise said at least one polysaccharide presilanized with a silanizing agent capable of forming said siloxane crosslinking bridges and preferably chosen from the group consisting of:

a) the compounds of formula (I)

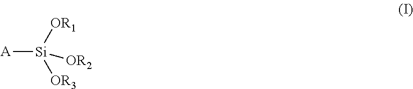

in which A represents a halogen atom or a C₁-C₂₀ alkyl group which is optionally substituted with an epoxide function, and R₁, R₂ and R₃ each represent, independently of one another, a straight or branched C₁-C₂₀ alkyl group or an alkali metal,

b) the compounds of formula (II)

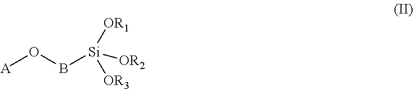

in which A represents a halogen atom or a C₁-C₂₀ alkyl group which is optionally substituted with an epoxide function, B represents a C₁-C₂₀ alkyl group, and R₁, R₂ and R₃ each represent, independently of one another, a straight or branched C₁-C₂₀ alkyl group or an alkali metal,

c) the compounds of formula (III)

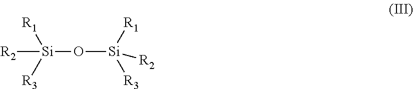

in which R₁, R₂ and R₃ each represent, independently of one another, a halogen atom or a C₁-C₂₀ alkyl group which is optionally substituted with an epoxide function, and

d) bisglycidoxypropyltetramethyldisilazane.

Even more preferentially, said silanizing agent is chosen from (3-glycidoxypropyl)trimethoxysilane, bisglycidoxypropyltetramethyldisilazane and glycidoxypropyltriisopropoxysilane.

Advantageously, said ionogel may also comprise inorganic nanofibers which form covalent bonds with said siloxane crosslinking bridges and which are preferably silica nanofibers which are predominantly anisotropic and mesoporous and which can have an aspect ratio close to 10. In this case, said ionogel forms a nanocomposite which can advantageously have an ionic conductivity at 25° C. of between 1.5 mS·cm⁻¹ and 5 mS·cm⁻¹.

Generally, a process according to the invention for manufacturing an ionogel as defined above essentially comprises silanization of said at least one polysaccharide in a basic aqueous solution with a silanizing agent, and polycondensation of the silanized polysaccharide.

Preferably, said at least one ionic liquid is hydrophobic, said silanizing agent being as defined above.

More specifically, an ionogel according to the invention may be manufactured according to two distinct processes, in accordance with the two embodiments presented hereinafter.

According to a first embodiment of the invention, this process comprises:
the preparation of a hydrogel based on said at least one polysaccharide that is silanized and crosslinked via the sol-gel route, by polycondensation in an aqueous medium (it being specified that, in the hydrogel, the polysaccharide confines water), then
successive reactions in which solvents of increasing hydrophobicities are exchanged.

It will be noted that the hydrogel can be cast or coated on a support in the form of a thin film, with variable thicknesses for the film which may be greater than or equal to 100 μm (such hydrogels are in particular presented in the abovementioned patent document WO-A1-97/05911 which teaches forming a hydrogel comprising a confinement matrix of silanized polysaccharide type by polycondensation).

Said reactions in which solvents of increasing hydrophobicities are exchanged may comprise:
a first exchange of solvents exchanging an aqueous solvent containing said at least one polysaccharide that is silanized and crosslinked via the sol-gel route with a nonaqueous first solvent based on a hydrophilic ionic liquid, for example 1,3-dimethylimidazolium methylphosphonate,
at least one intermediate exchange of solvents exchanging said nonaqueous first solvent with a less hydrophilic nonaqueous intermediate solvent, for example based on acetonitrile, and
a final exchange of solvents exchanging said nonaqueous intermediate solvent with said at least one hydrophobic ionic liquid.

According to a second preferential embodiment of the invention which has in particular the advantage of involving a shorter preparation time and a greater mass fraction of confined ionic liquid in comparison with said first embodiment, the process comprises direct mixing of a first solution comprising said at least one ionic liquid in an acid medium and of a second solution based on said at least one polysaccharide, that is silanized and noncrosslinked, in an aqueous basic medium, such that the crosslinking of said at least one polysaccharide via said siloxane bridges takes place by means of this mixing via the polycondensation of the polysaccharide in an ionic liquid medium.

Advantageously, these two embodiments may also comprise the addition of inorganic nanofibers, preferably silica nanofibers which are predominantly anisotropic and mesoporous and which can have an aspect ratio close to 10, which form covalent bonds with said siloxane crosslinking bridges of said at least one polysaccharide, so that the ionogel has an ionic conductivity at 25° C. of between 1.5 mS·cm⁻¹ and 5 mS·cm⁻¹.

Other characteristics, advantages and details of the present invention will emerge on reading the following description of several exemplary embodiments of the invention, given by way of nonlimiting illustration.

### EXAMPLES OF PREPARATION OF IONOGELS ACCORDING TO THE FIRST EMBODIMENT OF THE INVENTION

Hydroxypropylmethylcellulose (produced by the company Colorcon under the name Methocel E4M, and having a viscosity equal to 4000 cP at 25° C. with a mass fraction of 2% in water), presilanized by means of a silanizing agent consisting of (3-glycidoxypropyl)trimethoxysilane (abbreviated to “GPTMS”, produced by the company Sigma-Aldrich) according to the protocol described in the abovementioned patent document WO-A1-97/05911, was chemically crosslinked. The silanized and crosslinked HPMC product obtained constitutes the starting hydrogel (referred to as H1 hereinafter) intended to form the confinement matrix.

Added to the starting hydrogel H1 (containing 2% by weight of the silanized HPMC crosslinked by Si—O—Si bridges and 98% of an aqueous solution), during the preparation thereof, were anisotropic and mesoporous silica nanofibers having an aspect ratio close to 10, according to two mass fractions of these nanofibers equal to 1% and to 4% so as to obtain two other starting hydrogels H2 and H3, respectively.

Each hydrogel H1, H2 and H3 was then subjected to the same solvent exchange process comprising the following steps:

a) the aqueous solution of H1, H2 and H3 was exchanged against a hydrophilic ionic liquid consisting of 1,3-dimethylimidazolium methylphosphonate (abbreviated to MMIm MePhos) by immersing H1, H2 and H3 in two successive baths of this ionic liquid for 24 hours, respectively so as to obtain intermediate ionogels I1, I2 and I3;

b) after drying for 24 hours at 50° C. under an ambient atmosphere, this MMIm MePhos ionic liquid was exchanged against acetonitrile by placing these intermediate ionogels I1, I2 and I3 in a Soxhlet apparatus for 24 hours; then

c) immediately after this exchange, the samples obtained were placed for 24 hours in two successive baths containing a hydrophobic ionic liquid, and then they were dried for 24 hours at 50° C. under an ambient atmosphere, so as to obtain three final ionogels I1′, I2′ and I3′ according to the invention.

N-propyl-N-methylpyrrolidinium bis(trifluoromethanesulfonyl)-imide (abbreviated to Pyr13 TFSI) was used as hydrophobic ionic liquid to be confined.

All three of these hydrophobic ionogels I1′, I2′ and I3′ of the invention (derived from the hydrogels H1, H2 and H3 comprising respectively mass fractions of silica nanofibers of 0%, 1% and 4%) had a homogeneous and flexible self-supported structure (the flexibility having been characterized by manual bending tests). Table 1 hereinafter gives details, at each stage of the solvent exchange process, of the mass fractions of the four liquids (i.e. water, MMIm MePhos, acetonitrile and Pyr13 TFSI) in the total matrix+liquid having resulted in the ionogels I1′, I2′ and I3′, and of the total loss of volume between each ionogel I1′, I2′ and I3′ and each initial hydrogel H1, H2 and H3.

TABLE 1

| | | MMIm | | Pyr13 | Loss of |
|---|---|---|---|---|---|
| Samples | Water | MePhos | Acetonitrile | TFSI | volume |
| H1, I1, I1′ | 98% | 95% | 83% | 69% | 95% |
| H2, I2, I2′ | 98% | 95% | 85% | 83% | 93% |
| H3, I3, I3′ | 98% | 94% | 85% | 90% | 30% |

These results show that the loss of volume is minimized by the addition of the silica nanofibers, which interact by grafting with the Si—O—Si crosslinking bridges. Furthermore, the mass fraction of the Pyr13 TFSI in the ionogel I1′ devoid of nanofibers (69%) is less than the same mass fraction in the ionogels I2′ and I3′ containing these nanofibers (this Pyr13 TFSI fraction is at a maximum in the ionogel I3′ containing the most nanofibers), thereby showing the good affinity of the nanofibers with a hydrophobic ionic liquid such as Pyr13 TFSI.

Furthermore, “FTIR” (“Fourier Transform Infrared Spectroscopy”) analyses giving the respective spectra of MMIm MePhos, of Pyr13 TFSI and of the ionogels I1′, I2′ and I3′ showed that the latter contain, inside their matrix, the hydrophobic ionic liquid Pyr13 TFSI in the pure state. In other words, the solvent exchange was total so as to result in the ionogels I1′, I2′ and I3′.

Thermogravimetric analyses (TGA) were moreover carried out, consisting in measuring, as a function of temperature, the loss of mass of the samples of ionogels I1′, I2′ and I3′, of the silanized HPMC biopolymer and of the starting hydrogel H1. These TGA analyses showed that the degradation of the silanized HPMC polymer alone takes place at a temperature of 210° C., whereas this degradation occurs at a higher temperature (240° C.) in the crosslinked state in the hydrogel H1. Following the exchange of water with the Pyr13 TFSI ionic liquid, the heat stability of the silanized and crosslinked HPMC in the ionogel is improved, and remains stable up to 260° C., the threshold of degradation (above 400° C.) of this ionic liquid once confined being preserved.

Table 2 hereinafter gives the ionic conductivities measured at 20° C. by complex impedance spectroscopy for the three ionogels I1′, I2′ and I3′ of the invention, in comparison with that of the Pyr13 TFSI ionic liquid (following drying under vacuum at 50° C. for 24 hours).

TABLE 2

| | Pyr13 TFSI | I1′ | I2′ | I3′ |
|---|---|---|---|---|
| σ (mS · cm⁻¹) | 2.8 | 0.7 | 1.5 | 4.5 |

These results show that the ionic conductivity of 0.7 mS·cm⁻¹ which characterizes the ionogel I1′ devoid of silica nanofibers is comparable to or even higher than the ionic conductivities of known, polysaccharide-based ionogels. Furthermore, the addition of these silica nanofibers makes it possible to considerably increase this conductivity, as shown in particular by the ionic conductivity of 4.5 mS·cm⁻¹ which is obtained with 4% of these nanofibers and which is higher than that of the nonconfined ionic liquid, even at temperatures above 20° C. reaching 90° C.

### Examples of Preparation of Ionogels According to the Second Embodiment of the Invention

The same hydroxypropylmethylcellulose as for the abovementioned first embodiment was chemically silanized by means of the same “GPTMS” silanizing agent, and the same liquid as for this first embodiment (Pyr13 TFSI) was used as ionic liquid to be confined.

Solutions 1 and 2 were first of all prepared as follows:
solutions 1: various amounts of silica nanofibers ranging from 0 to 80 mg (identical to those of the first embodiment) were mixed with 1 ml of acetonitrile and with 1.7 ml of formic acid, then the solution obtained was placed in an ultrasonic bath for 1 hour. The Pyr13 TFSI ionic liquid was then added thereto according to various amounts ranging from 0.47 g to 1 g, so as to obtain a series of various solutions 1;
solution 2: this single solution 2 forming the gel was prepared by introducing 3 g of the silanized and noncrosslinked HPMC polymer into a closed flask containing 97 ml of aqueous NaOH solution (0.2 mol·l⁻¹), and stirring for 48 hours at ambient temperature. The solution obtained was then dialyzed at ambient temperature, a first time against 1.9 l of sodium hydroxide solution (0.09 mol·l⁻¹) for 20 hours, and then a second time against 2 l of this sodium hydroxide solution (0.09 mol·l⁻¹) for 1 hour 30 minutes.

Each solution 1 was then mixed with 0.5 ml of solution 2 by syringe exchange, said mixing having the effect of crosslinking the silanized HPMC.

Each mixture thus obtained was shaped either by casting in a mold, or by coating at a thickness of 200 μm on a depositing substrate such as a glass slide or a sheet of PET (for example Mylar®).

Each mixture was gelled, followed by evaporation of the solvents for a period ranging from 1 day to 3 days.

Whether the ionogels thus obtained are cast or coated, their ionic conductivity (measured at 25° C. by impedance spectroscopy) was about 0.8 mS·cm⁻¹ to 5.0 mS·cm⁻¹, like the relatively high conductivities obtained by means of the abovementioned first embodiment.

In the preferential case of the ionogels cast in a mold, they had average thicknesses, measured using a “Palmer” device for this thickness range, of between 100 μm and 900 μm.

In the case of ionogels deposited as thin films, they had variable thicknesses, measured by mechanical profilometry for this thickness range, of between 10 μm and 100 μm.

1. A monolithic ionogel comprising a biopolymer confinement matrix based on at least one crosslinked polysaccharide and at least one ionic liquid confined in a network formed by said matrix, characterized in that at least one polysaccharide has siloxane crosslinking bridges, the ionogel being a chemical gel capable of constituting a self-supported solid electrolyte by itself.

2. The ionogel as claimed in claim 1, characterized in that said ionogel has an average thickness greater than or equal to 10 μm and an ionic conductivity at 25° C. greater than or equal to 0.7 mS·cm⁻¹.

3. The ionogel as claimed in claim 1, characterized in that said confinement matrix is devoid of any molecular precursor of sol-gel type derived from silane, such as an alkoxysilane.

4. The ionogel as claimed in claim 1, characterized in that at least one polysaccharide is a cellulose-based derivative preferably chosen from the group consisting of hydroxyethylcellulose, hydroxyethylmethylcellulose, hydroxypropylcellulose, hydroxypropylmethylcellulose, hydroxypropyloxymethoxycellulose and mixtures thereof.

5. The ionogel as claimed in claim 1, characterized in that at least one ionic liquid comprises:
by way of cation, a nucleus which comprises a nitrogen atom and which is chosen from imidazolium, pyridinium, pyrrolidinium and piperidinium nuclei, this nucleus preferably being substituted on the nitrogen atom with one or two alkyl groups having from 1 to 8 carbon atoms and on the carbon atoms with one or more alkyl groups having from 1 to 30 carbon atoms; and
by way of anion, a halide, a perfluoro anion, a phosphonate, a dicyanamide or a borate, said anion preferably being a bis(trifluoromethanesulfonyl)imide.

6. The ionogel as claimed in claim 1, characterized in that said at least one ionic liquid is hydrophobic.

7. The ionogel as claimed in claim 1, characterized in that said ionogel comprises at least one polysaccharide presilanized with a silanizing agent which is capable of forming said siloxane crosslinking bridges and which is preferably chosen from the group consisting of:
(a) the compounds of formula (I); 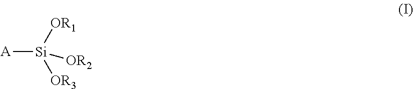
in which A represents a halogen atom or a C₁-C₂₀ alkyl group optionally substituted with an epoxide function, and R₁, R₂ and R₃ each represent, independently of one another, a straight or branched C₁-C₂₀ alkyl group or an alkali metal,
(b) the compounds of formula (II); 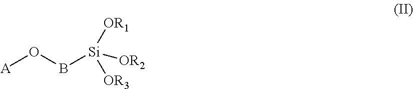
in which A represents a halogen atom or a C₁-C₂₀ alkyl group optionally substituted with an epoxide function, B represents a C₁-C₂₀ alkyl group, and R₁, R₂ and R₃ each represent, independently of one another, a straight or branched C₁-C₂₀ alkyl group or an alkali metal,
c) the compounds of formula (III); 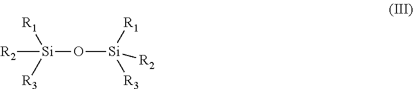
in which R₁, R₂, and R₃ each represent, independently of one another, a halogen atom or a C₁-C₂₀ alkyl group optionally substituted with an epoxide function; and
(d) bisglycidoxypropyltetramethyldisilazane.

8. The ionogel as claimed in claim 1, characterized in that said ionogel also comprises inorganic nanofibers which form covalent bonds with said siloxane crosslinking bridges and which are preferably silica nanofibers which are predominantly anisotropic and mesoporous.

9. The ionogel as claimed in claim 8, characterized in that said ionogel has an ionic conductivity at 25° C. of between 1.5 mS·cm⁻¹ and 5 mS·cm⁻¹.

10. A process for manufacturing an ionogel as claimed in claim 1, characterized in that it essentially comprises silanization of at least one polysaccharide in a basic aqueous solution with a silanizing agent, and polycondensation of the silanized polysaccharide.

11. The process as claimed in claim 10, characterized in that it comprises the preparation of a hydrogel based on said at least one polysaccharide that is silanized and crosslinked by the sol-gel route, by polycondensation in an aqueous medium, then successive reactions in which solvents of increasing hydrophobicities are exchanged, comprising:
a first exchange of solvents exchanging an aqueous solvent containing said at least one polysaccharide that is silanized and crosslinked via the sol-gel route with a nonaqueous first solvent based on a hydrophilic ionic liquid, for example 1,3-dimethylimidazolium methylphosphonate;
at least one intermediate exchange of solvents exchanging said nonaqueous first solvent with a less hydrophilic nonaqueous intermediate solvent, for example based on acetonitrile; and
a final exchange of solvents exchanging said nonaqueous intermediate solvent with said at least one hydrophobic ionic liquid.

12. The process as claimed in claim 10, characterized in that it comprises direct mixing of a first solution comprising said at least one ionic liquid in an acid medium and of a second solution containing at least one silanized and noncrosslinked polysaccharide in an aqueous basic medium, such that the crosslinking of said at least one polysaccharide via said siloxane bridges takes place by means of this mixing via the polycondensation of the polysaccharide in an ionic liquid medium.

13. The process as claimed in claim 1, characterized in that it also comprises the addition of inorganic nanofibers, preferably silica nanofibers which are predominantly anisotropic and mesoporous, which form covalent bonds with said siloxane crosslinking bridges of said at least one polysaccharide, so that said ionogel has an ionic conductivity at 25° C. of between 1.5 mS·cm⁻¹ and 5 mS·cm⁻¹.
